(19) United States
(12) Patent Application Publication
(10) Pub. No.: US 2015/0140372 A1
(43) Pub. Date: May 21, 2015

(54) HERMETICALLY-SEALED BATTERY

(71) Applicant: SMK Corporation, Tokyo (JP)

(72) Inventor: Haruhiko Kondo, Kanagawa (JP)

(21) Appl. No.: 14/549,060

(22) Filed: Nov. 20, 2014

(30) Foreign Application Priority Data
Nov. 20, 2013 (JP) 2013-240091

(51) Int. Cl. H01M 2/04; H01M 2/12

(52) U.S. Cl. CPC H01M 2/043; H01M 2/12; H01M 2220/20
USPC 429/56; 429/185

(57) ABSTRACT

A hermetically-sealed battery including a case body made of a metal, power generation elements housed in the case body, and a lid plate made of a metal. The case has an opening. The lid plate is fitted into the opening of the case body. The lid plate has a periphery laser-welded together with the case body to hermetically seal the opening of the case body with the lid plate. The lid plate includes a frame piece integrally provided along the periphery of the lid plate so as to be perpendicular to a plane surface of the lid plate. The frame piece is pressed into the opening along an inner wall surface. Laser welding is performed along a boundary between the frame piece and the inner wall surface that are in pressure contact with each other.

### FIELD

The present invention relates to a hermetically-sealed battery in which an opening of a case body with power generation elements housed therein is sealed with a lid plate. More specifically, the present invention relates to a hermetically-sealed battery in which a periphery of a lid plate fitted into an opening of a case body is laser-welded so as to hermetically seal the opening with the lid plate.

### BACKGROUND

A hermetically-sealed battery is obtained by housing power generation elements such as an electrolyte and a wound electrode body in a bottomed tubular case body made of a metal and sealing an opening of the case body with a lid plate made of a metal plate. A hermetically-sealed battery such as a lithium-ion secondary battery or a nickel-hydrogen secondary battery, for example, is installed in a vehicle using electricity as a driving source or an electrical product such as a mobile communication unit and used as a power source thereof.

In order to prevent the leakage of the electrolyte or the like housed in the case body, the opening of the case body needs to be hermetically sealed with the lid plate completely. According to a conventional hermetically-sealed battery 100, as shown in FIG. 16, a lid plate 103 made of a metal plate is housed in an opening 102 of a case body 101 made of a metal and a laser beam is irradiated along an entire boundary between a periphery of the lid plate 103 and an opening edge of the opening 102 so as to laser-weld the case body 101 and the lid plate 103 (Patent Literature 1).

As the thickness of the lid plate 103 for covering the opening 102 is increased, the weight of the lid plate 103 is increased. Thus, in an electric car or a hybrid car in which a large number of hermetically-sealed batteries are installed, the total weight is increased, thereby leading to poor fuel efficiency. Further, the lid plate in this type of hermetically-sealed battery is provided with an explosion-proof valve including a thin-walled portion in order to prevent an accident due to the explosion of the hermetically-sealed battery, wherein the thin-walled portion will be broken by a predetermined internal pressure increase in the case body. If the thickness of the lid plate 103 is increased, however, a processing load when processing a thin-walled portion from the lid plate 103 by means of pressing reaches a limit in processing by means of a press mold. Thus, the thin-walled portion cannot be integrally formed from the lid plate 103. Furthermore, when the thickness of the lid plate 103 is increased, the material cost and processing cost thereof are also increased, resulting in a high manufacturing cost. This is not desirable also from an economic point of view.

If the thickness of the lid plate 103 is set thin, in contrast, a sufficiently long welding margin with respect to the case body 101 cannot be ensured. Consequently, a welding strength with respect to the case body 101 cannot be obtained and the strength of the lid plate 103 itself also cannot be obtained. Thus, the lid plate 103 may possibly bend outwardly upon receipt of an internal pressure of the case body 101.

In view of this, a hermetically-sealed battery 110 has been proposed in which a lid plate 113 is firmly fitted into an opening 112 of a case body 111 and laser welding is performed along the periphery thereof in order to achieve a sufficient laser welding strength with respect to the case body even when the lid plate is made thin (Patent Literature 2). According to the hermetically-sealed battery 110, an inner side surface 112a of the opening 112 of the case body 111 is formed as an inclined surface inclining from an opening edge toward an inner side as shown in FIG. 17. The lid plate 113 with an outer shape approximately equal to an inner diameter of the opening edge is pressed into the inner side surface 112a so as to firmly fit the lid plate 113 into the opening 112. A laser beam is irradiated along the opening edge so as to form a laser welded portion 114 in the boundary between the periphery of the lid plate 113 and the case body 111.

According to the hermetically-sealed battery 110, the laser welding strength between the lid plate 113 and the case body 111 is supplemented by the firm fitting between the lid plate 113 and the case body 111. Thus, the lid plate 113 is firmly joined to the case body 111, thereby hermetically sealing the opening 112 with the lid plate 113 more completely.

A hermetically-sealed battery has been also known in which a lid plate is disposed on an end face of an opening of a case body and a laser beam is then irradiated along a boundary between the lid plate and the case body, which is present on a side surface of the case body, so as to join therebetween with a sufficient laser welding strength independently of the thickness of the lid plate (Patent Literature 3).

### CITATION LIST

### Patent Literature

Patent Literature 1: Japanese Patent Application Laid-Open No. 2013-187087
Patent Literature 2: Japanese Patent Application Laid-Open No. 2010-238404
Patent Literature 3: Japanese Patent Application Laid-Open No. 2013-91085

### SUMMARY

### Technical Problem

According to the conventional hermetically-sealed battery 100, the lid plate 103 made of an aluminum alloy, for example, needs to have a thickness t of 1.5 mm or greater, for example, in order to obtain a laser welding strength by providing a welding margin of a certain length with respect to the case body 101. Due to the resultant weight increase, the fuel efficiency of an electric car or a hybrid car with a large number of hermetically-sealed batteries 100 installed therein deteriorates.

Moreover, as the thickness of the lid plate 103 is increased, the material cost and processing cost thereof are also increased, resulting in an increased manufacturing cost.

Furthermore, a thin-walled portion of an explosion-proof valve cannot be integrally formed by means of pressing from the lid plate 103 with a thickness exceeding a predetermined thickness. Therefore, a separately-formed explosion-proof valve needs to be fixed to the lid plate 103 by means of welding. Consequently, the number of manufacturing steps is increased, thereby leading to a further increase in the manufacturing cost.

According to the conventional hermetically-sealed battery 110 in which the lid plate 113 is fixed to the case body 111 by means of laser welding and firm fitting therebetween, the outer diameter of the lid plate 113 is required to satisfy a high level of manufacturing tolerance of about 0.2 mm. When exceeding the maximum acceptable dimension, the lid plate 113 cannot be fitted into the case body 111. When smaller than the minimum acceptable dimension, the lid plate 113 may fall in the opening 112 of the case body 111 or a gap may be created between the lid plate 113 and the inner side surface 112a of the opening 112. Consequently, airtightness in the case body 111 deteriorates.

Furthermore, if the thickness of the lid plate 113 is made thin, the lid plate 113 may be bent when pressing the lid plate 113 into the inner side surface 112a. Consequently, a gap may be created between the lid plate 113 and the inner side surface 112a, resulting in deteriorated airtightness, or a laser beam may pass through such a gap, i.e., laser leakage may be generated, thereby failing to completely laser welding the entire periphery of the lid plate 113.

Moreover, as described in Patent Literature 3, according to the method of joining the case body and the lid plate together by means of laser welding along the boundary between the case body and the lid plate present on the side surface of the case body, a laser beam is irradiated around the outer circumference of the tubular case body from the side. Thus, as compared with a case where a laser beam is irradiated from above, a device for achieving a relative rotary movement around an axis needs to be provided in a laser irradiation apparatus. In order to irradiate the entire boundary without any displacement in the irradiation position, precise control is required.

Furthermore, the laser welded portion bulges on the side surface of the case body. Thus, when stacking a large number of hermetically-sealed batteries for installation in a vehicle or the like, the hermetically-sealed batteries cannot be stacked orderly since such a bulging portion acts as an obstacle.

Moreover, as compared with a case where laser welding is performed along the periphery of the opening of the case body, the total welding distance is increased since laser welding is performed along the outer side surface of the case body. Thus, the probability of causing a positioning failure of the lid plate with respect to the case body or a welding failure due to laser beam leakage is increased.

The present invention has been made in view of such conventional problems. It is an object of the present invention to provide a hermetically-sealed battery capable of ensuring a welding margin with a predetermined length even when a lid plate is made thin and thereby obtaining a laser welding strength.

Moreover, it is another object of the present invention to provide a hermetically-sealed battery capable of maintaining flatness even when a lid plate is made thin and therefore capable of fitting the lid plate into an opening of a case body with high dimensional accuracy without a bend when the lid plate is pressed into the opening.

### Solution to Problem

In order to achieve the aforementioned objects, a first aspect of the present invention provides a hermetically-sealed battery including: a case body made of a metal and having an opening; power generation elements housed in the case body; and a lid plate made of a metal, the lid plate being fitted into the opening of the case body, the lid plate having a periphery laser-welded together with the case body so as to hermetically seal the opening of the case body with the lid plate, wherein the lid plate includes a frame piece integrally provided along the periphery of the lid plate so as to be perpendicular to a plane surface of the lid plate, the frame piece is pressed into the opening along an inner wall surface thereof, and laser welding is performed along a boundary between the frame piece and the inner wall surface that are in pressure contact with each other.

Even when the thickness of the lid plate is made thin, a sufficiently long welding margin is formed between the inner wall surface of the opening and the frame piece in pressure contact with each other. Thus, a high laser welding strength can be obtained.

Due to the formation of the frame piece along the periphery of the lid plate in the direction perpendicular to the plane surface of the lid plate, rigidity to maintain flatness can be obtained even when the thickness of the lid plate is made thin. Thus, the lid plate is less likely to bend. Therefore, no bending occurs even when the frame piece is pressed into the opening along the inner wall surface thereof. Accordingly, the lid plate can be pressed into the opening along the inner wall surface thereof while keeping high dimensional accuracy of the outline thereof, thereby firmly fitting the lid plate into the opening without any gap created therebetween. Moreover, since the lid plate is less likely to bend even when the lid plate is made thin, the lid plate is prevented from bending outwardly due to an internal pressure in the case body.

The lid plate is firmly fitted into the opening and laser welding between the frame piece along the periphery of the lid plate and the case body is performed with a sufficiently long welding margin. Thus, the lid plate is firmly joined to the case body.

In the hermetically-sealed battery according to a second aspect of the present invention, the frame piece has an outer side surface provided with an inclined surface for guiding the frame piece toward an inner side of the opening while abutting against an opening edge of the opening when the frame piece is pressed into the opening along the inner wall surface thereof.

Simply by pushing the lid plate into the opening with the inclined surface abutting against the opening edge of the opening, the outer side surface of the frame piece and the inner wall surface of the opening are in pressure contact with each other, thereby firmly fitting the lid plate into the opening.

In the hermetically-sealed battery according to a third aspect of the present invention, the periphery of the lid plate has a rectangular shape, and a plurality of ribs along a longitudinal direction and a short-side direction of the rectangular shape are formed on the plane surface and/or a rear surface of the lid plate.

Due to the formation of the plurality of ribs along the longitudinal direction and the short-side direction of the lid plate with the rectangular periphery, rigidity to maintain a higher level of flatness can be obtained in cooperation with the frame piece provided along the periphery. Thus, no bending occurs in the lid plate.

In the hermetically-sealed battery according to a fourth aspect of the present invention, the lid plate includes an explosion-proof valve integrally formed therein, the explosion-proof valve including a thin-walled portion which is broken when an internal pressure in the case body reaches a certain value.

The thin-walled portion can be integrally formed from the lid plate with a small thickness with a load before reaching a limit processing load.

In the hermetically-sealed battery according to a fifth aspect of the present invention, the frame piece and the explosion-proof valve are formed in the lid plate by processing a thin metal plate by means of pressing.

The frame piece and the thin-walled portion of the explosion-proof valve can be formed by a series of pressing steps.

### Advantageous Effects of Invention

According to the first aspect of the present invention, by reducing the thickness of the lid plate capable of being joined to the case body with a sufficient strength, the weight of the hermetically-sealed battery can be reduced, thereby achieving a reduction in the manufacturing cost.

Moreover, even when the lid plate is made thin, no bending deformation occurs when the lid plate is pressed into the opening along the inner wall surface thereof. Thus, the lid plate can be firmly fitted into the opening of the case body without any gap created therebetween. Accordingly, no laser leakage occurs during laser welding, thereby achieving a high level of airtightness with the lid plate.

Moreover, even when the lid plate is made thin, the lid plate is prevented from bending outwardly due to an internal pressure in the case body.

According to the second aspect of the present invention, simply by pushing the frame piece into the opening with the inclined surface thereof abutting against the opening edge of the opening, the lid plate can be firmly fitted into the opening.

According to the third aspect of the present invention, rigidity to maintain a higher level of flatness in the lid plate can be obtained in cooperation with the frame piece. Thus, the lid plate with a smaller thickness can be firmly fitted into the opening.

According to the fourth aspect of the present invention, since the thin-walled portion of the explosion-proof valve can be integrally formed in the lid plate, steps of manufacturing an explosion-proof valve separately and welding the explosion-proof valve to the lid plate are eliminated, thereby simplifying the manufacturing steps.

According to the fifth aspect of the present invention, since the frame piece and the thin-walled portion of the explosion-proof valve are formed by the series of pressing steps, the manufacturing steps can be simplified.

### BRIEF DESCRIPTION OF DRAWINGS

FIG. 1 is a front view illustrating a hermetically-sealed battery 1 according to an embodiment of the present invention.

FIG. 2 is a perspective view of a case body 4.

FIG. 3 is a plan view of a lid plate 2.

FIG. 4 is a rear view of the lid plate 2.

FIG. 5 is a side view of the lid plate 2.

FIG. 6 is a front view of the lid plate 2.

FIG. 7 is a cross-sectional view taken along the line A-A in FIG. 3.

FIG. 8 is an enlarged cross-sectional view illustrating a main part of a periphery of the lid plate 2.

FIG. 9 is an enlarged cross-sectional view illustrating a main part of an explosion-proof valve 3.

FIG. 10 is a cross-sectional view taken along the line B-B in FIG. 3.

FIG. 11 is a cross-sectional view taken along the line C-C in FIG. 3.

FIG. 12 is an enlarged cross-sectional view illustrating a main part in a state when pressing the lid plate 2 into an opening 5 of the case body 4.

FIG. 13 is an enlarged cross-sectional view illustrating a main part in a state in which the lid plate 2 is firmly fitted into the opening 5 of the case body 4.

FIG. 14 is a rear view of a lid plate 31 in a hermetically-sealed battery 30 according to another embodiment of the present invention.

FIG. 15 is a longitudinal cross-sectional view of the lid plate 31 taken along the line D-D in FIG. 14.

FIG. 16 is a front view illustrating the conventional hermetically-sealed battery 100 with an enlarged cross-sectional view illustrating a main part thereof.

FIG. 17 is an enlarged cross-sectional view illustrating a main part of the conventional hermetically-sealed battery 110.

### DESCRIPTION OF EMBODIMENTS

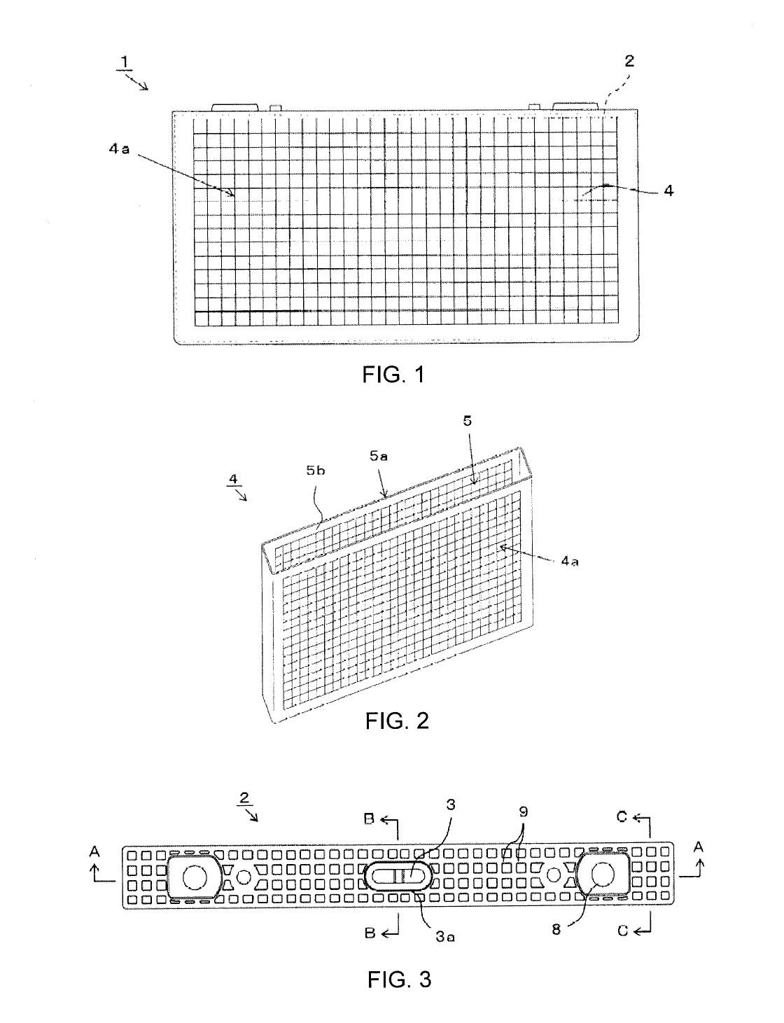

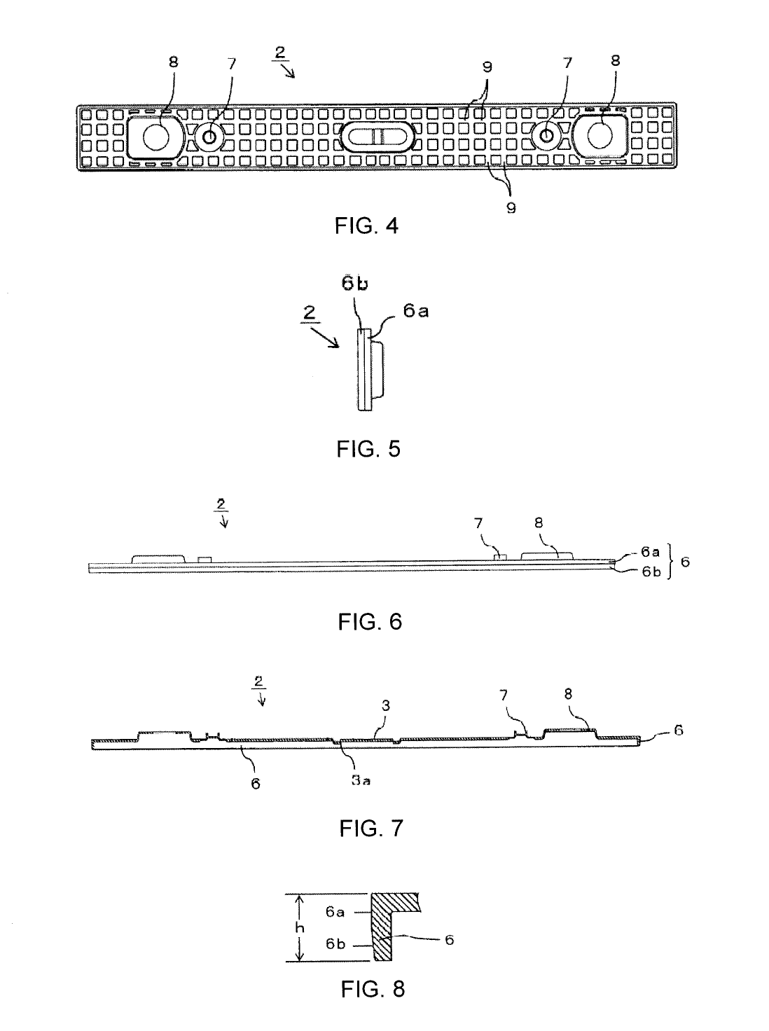

A hermetically-sealed battery 1 according to an embodiment of the present invention will be described with reference to FIGS. 1 to 13. FIG. 1 is a front view of the hermetically-sealed battery 1. The hermetically-sealed battery 1 is obtained by: fitting a lid plate 2 into an opening 5 on a plane surface side of a case body 4 with power generation elements such as an electrolyte, a wound electrode body, and a separator housed therein; and performing laser welding along a periphery of the lid plate 2 and an opening edge 5a of the opening 5 so as to seal the opening 5 with the lid plate 2.

The case body 4 is made of an aluminum alloy plate or a stainless steel thin plate. Here, the case body 4 is formed by subjecting an aluminum alloy plate to raising so as to have a bottomed tubular outer shape of an elongated rectangular parallelepiped. The plane surface side of the case body 4 having the shape of the bottomed square tube is opened so as to form the rectangular opening 5 inside a tubular inner wall surface. Also, a front side and a rear side of the case body 4 are provided with a checkered uneven surface 4a with square depressed surfaces and square protruding surfaces continuously adjoining in an alternate manner. Consequently, even if the thickness of the case body 4 is reduced to 1 mm or less in order to achieve a reduction in the weight thereof, predetermined rigidity to prevent the bending thereof due to an internal pressure can be obtained.

The lid plate 2 for covering the opening 5 is formed by subjecting a thin aluminum alloy plate with a thickness of 0.8 mm to pressing. The lid plate 2 is formed in the shape of an elongated rectangular plate shown in FIGS. 3 to 11. The periphery of the rectangular lid plate 2 is subjected to pressing so as to form a frame piece 6 integrally suspending around the entire periphery thereof downwardly in a direction perpendicular to a plane surface of the lid plate 2 as shown in FIGS. 7 and 8. The thickness of the frame piece 6 formed by the pressing is approximately equal to 0.8 mm, which is the thickness of the raw material of the lid plate 2. The height h of an outer side surface of the frame piece 6 is 3 mm, which is about 3 times the thickness (0.8 mm) of the raw material.

The outer side surface of the frame piece 6 is divided into a vertical surface 6a extending along a vertical direction from a middle position to an upper end thereof and an inclined surface 6b extending from the middle position to a lower end thereof and inclined inwardly and downward. The vertical surface 6a and the inclined surface 6b are each annularly formed with a vertical width of about 1.5 mm over the entire periphery of the frame piece 6. Due to the formation of the frame piece 6 along the entire periphery of the lid plate 2, a width between the vertical surfaces 6a facing each other in a longitudinal direction (the width of the lid plate 2 in the longitudinal direction) is 168.4 mm and a width between the vertical surfaces 6a facing each other in a short-side direction (the width of the lid plate 2 in the short-side direction) is 18.4 mm. Such widths are slightly longer (here, 0.4 mm) than distances between inner wall surfaces 5b facing each other in the longitudinal direction and in the short-side direction of the rectangular opening 5, respectively. On the other hand, distances between the lower ends of the inclined surfaces 6b facing each other in the longitudinal direction and in the short-side direction of the lid plate 2 are shorter than the distances between the inner wall surfaces 5b facing each other in the longitudinal direction and in the short-side direction of the opening 5, respectively. Thus, when the lid plate 2 is disposed above the opening 5, the opening edge 5a of the opening 5 abuts against the inclined surface 6b, thereby temporarily holding the lid plate 2 above the opening 5 as shown in FIG. 12.

As shown in FIGS. 3, 9, and 10, an explosion-proof valve 3 having an oval thin-walled portion 3a as an outline thereof is formed approximately at a center of the lid plate 2. The explosion-proof valve 3 is a safety valve for the prevention of a danger. Before the case body is exploded due to an abnormal increase in an internal pressure inside the hermetically-sealed battery 1, the explosion-proof valve 3 causes the thin-walled portion 3a to break at a predetermined internal pressure and thereby releases the increasing internal pressure to the outside. Here, in order to reliably break the thin-walled portion 3a at an internal pressure of 0.7 MPa, the thickness thereof is set at 0.03 mm. In order to process the lid plate 2 with a thickness of 0.8 mm into the thin-walled portion 3a with a thickness of 0.03 mm, the center of the lid plate 2 at which the explosion-proof valve 3 is formed is interposed between upper and lower dies with blade side surfaces thereof overlapped with each other with a clearance of 0.08 mm in a horizontal direction and the overlapped portion of the lid plate 2 is compressed to a thickness of 0.03 mm. In this manner, the thin-walled portion 3a is cold-forged. During this cold-forging, the thickness of the lid plate 2 is thin as small as 0.8 mm and only the overlapped portion is compressed while shearing the lid plate 2 along both sides of a region where the blade side surfaces of the dies are overlapped with each other. Thus, the thin-walled portion 3a can be formed without increasing a processing load on the dies.

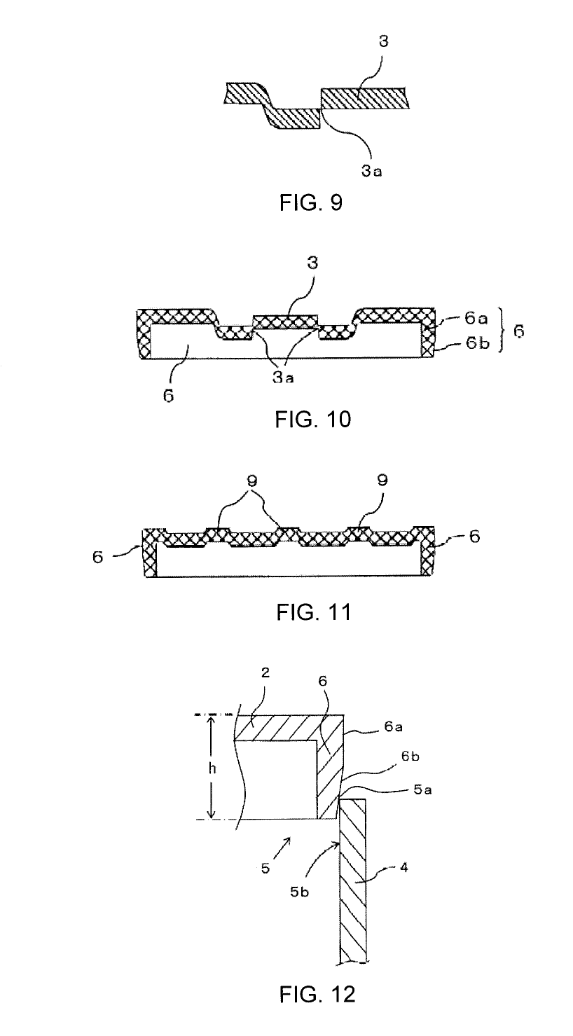

In addition, positioning depressed parts 7 used for positioning a decorative sheet for covering the lid plate 2, electrode insertion parts 8 through which electrodes are inserted via gaskets, and a large number of ribs 9 formed on the remaining plane surface with a regular pitch along the longitudinal direction and the short-side direction are provided in the lid plate 2 by means of pressing. As shown in FIGS. 3 and 11, due to the large number of ribs 9 formed in an intersecting manner between the longitudinal direction and the short-side direction, a secondary moment of area in the lid plate 2 is increased in any of the directions orthogonal to each other. Thus, even when the lid plate 2 is formed from a thin-walled plate with a thickness of 0.8 mm, rigidity to prevent deterioration in the flatness thereof can be imparted. Consequently, the lid plate 2 can possess a high level of rigidity in cooperation with the frame piece 6 formed with a large thickness along the entire periphery of the lid plate 2. Thus, the lid plate 2 is prevented from bending outward due to an internal pressure inside the hermetically-sealed battery 1.

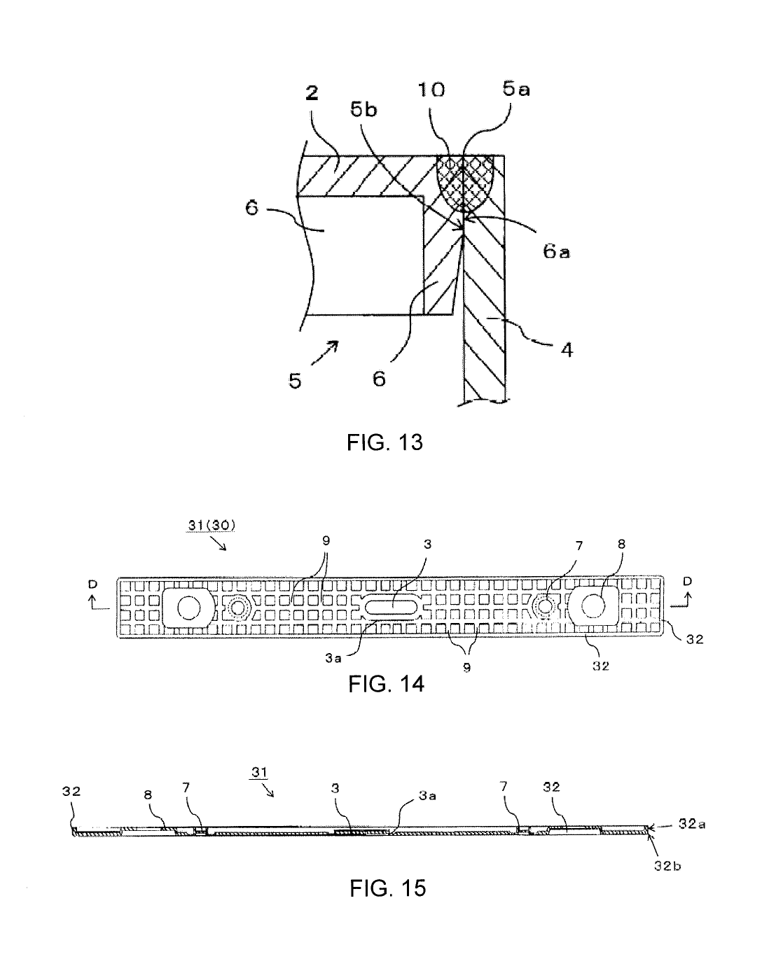

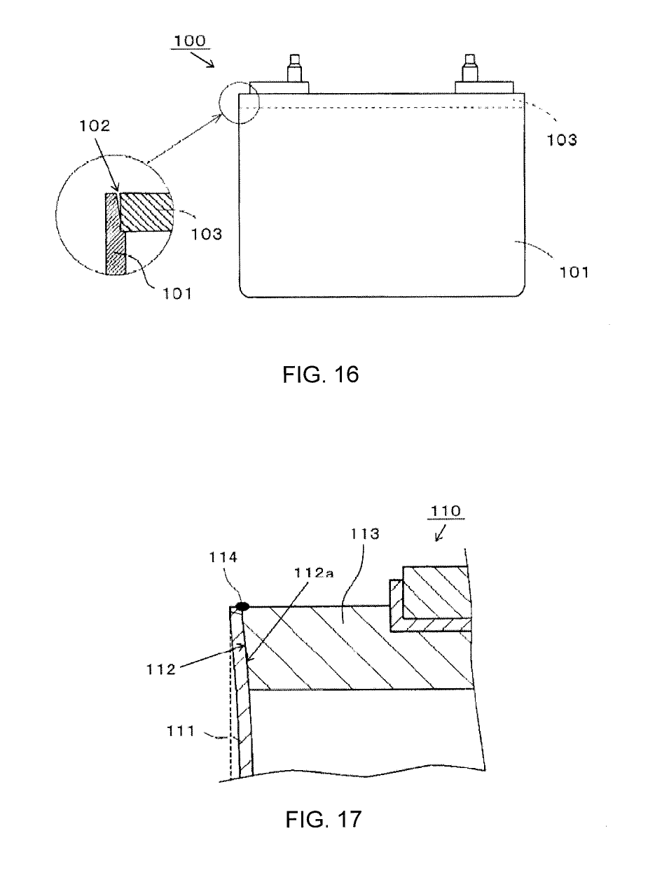

After the power generation elements are housed in the case body 4, the thus configured lid plate 2 is disposed above the opening 5 with the inclined surface 6b of the frame piece 6 abutting against the opening edge 5a of the opening 5 as shown in FIG. 12. The periphery of the lid plate 2 is pushed into the opening 5 from above, thereby achieving the press fitting of the frame piece 6 along the inner wall surface 5b of the opening 5. As a result of the press fitting of the frame piece 6 along the inner wall surface 5b, the inclined surface 6b of the frame piece 6 guides the frame piece 6 to the inside of the opening 5. Consequently, the vertical surface 6a of the frame piece 6 and the inner wall surface 5b of the opening 5 are in pressure contact with each other as shown in FIG. 13. The lid plate 2 is thus fitted into the opening 5 of the case body 4 firmly.

With the lid plate 2 firmly fitted into the opening 5, i.e., positioned in the case body 4 without backlash, a laser beam is irradiated along the entire periphery of the lid plate 2, i.e., the entire boundary between the vertical surface 6a of the frame piece 6 and the inner wall surface 5b of the opening 5. As shown in FIG. 13, along the boundary between the periphery of the lid plate 2 and the inner wall surface 5b on which the laser beam is irradiated, a laser welded portion 10 is formed as a result of the erosion by the laser beam and resultant welding therebetween. According to the present embodiment, the vertical surface 6a of the frame piece 6 is formed with a length longer than the thickness of the lid plate 2 in the vertical direction and therefore a sufficiently long welding margin for welding by the laser beam is ensured in the thin-walled lid plate 2. Thus, the periphery of the lid plate 2 and the case body 4 are laser-welded with a sufficient welding strength. Furthermore, since the lid plate 2 is firmly fitted into the opening 5 of the case body 4, the lid plate 2 is firmly fixed to the case body 4. Accordingly, the entire periphery of the lid plate 2 is firmly adhered to the inner wall surface 5b of the opening 5 without any gap created therebetween, thereby hermetically sealing the opening 5 completely.

Herein, the case body 4 is formed in the bottomed square tubular shape by means of raising as described above. Thus, the processing accuracy thereof has a limit, thereby resulting in variations in the inner wall surface 5b of the opening 5. On the other hand, the lid plate 2 formed with an outer diameter slightly longer than an inner diameter of the opening 5 has a high level of rigidity. Therefore, the outline of the lid plate 2 does not change during the press fitting of the frame piece 6 along the inner wall surface 5b. Thus, the slightly longer vertical surface 6a of the frame piece 6 pushes out the inner wall surface 5b of the opening 5, thereby making the inner wall surface 5b an even plane parallel to the vertical surface 6a. Consequently, the frame piece 6 and the inner wall surface 5b of the opening 5 are in close contact with each other without any gap created therebetween with the lid plate 2 firmly fitted into the opening 5 of the case body 4. Therefore, the laser beam is prevented from leaking into the case body 4 through such a gap. Thus, there is no risk of laser leakage.

FIGS. 14 and 15 show a lid plate 31 of a hermetically-sealed battery 30 according to a second embodiment of the present invention. The hermetically-sealed battery 30 is different from the hermetically-sealed battery 1 according to the first embodiment only in terms of the direction of a frame piece 32 perpendicular to a plane surface of the lid plate 31. Thus, constituent elements identical with or similar to those of the hermetically-sealed battery 1 will be denoted by the same reference numerals and the description thereof will be omitted.

As shown in FIGS. 14 and 15, the lid plate 31 is provided with the frame piece 32 formed by being integrally formed while being bended upwardly in a direction perpendicular to the plane surface of the lid plate 31 along the entire periphery thereof. Thus, the lid plate 31 is formed in a rectangular box shape. As with the frame piece 6 according to the first embodiment, the thickness of the frame piece 32 formed by means of pressing is approximately equal to 0.8 mm, which is the thickness of the lid plate 31. Also, the height of an outer side surface of the frame piece 32 is 3 mm, which is about 3 times the thickness (0.8 mm) of the lid plate 31.

The entire outer side surface of the frame piece 32 serves as a vertical surface 32a. Widths between the vertical surfaces 32a facing each other in the longitudinal direction and in the short-side direction are slightly longer than distances between the inner wall surfaces 5b facing each other in the longitudinal direction and in the short-side direction of the rectangular opening 5, respectively. No inclined surface such as the inclined surface 6b according to the first embodiment is formed on the outer side surface of the frame piece 32. However, since a curved surface 32b is formed at a lower end of the outer side surface of the frame piece 32 when bending the frame piece 32 from the periphery of the lid plate 31, the curved surface 32b is used to act as an inclined surface for guiding the frame piece 32 into the opening 5 by abutting the curved surface 32b against the opening edge 5a of the opening 5. The frame piece 32 is thereby press-fitted along the inner wall surface 5b of the opening 5 with the curved surface 32b abutting against the opening edge 5a. Thus, the lid plate 31 is firmly fitted into the opening 5.

With the thus configured lid plate 31 firmly fitted into the opening 5, i.e., positioned and held in the case body 4 without backlash, a laser beam is irradiated on the entire periphery of the lid plate 31 along the boundary between the vertical surface 32a of the frame piece 32 and the inner wall surface 5b of the opening 5. In this manner, the lid plate 31 is laser-welded to the case body 4. The height (length) of the vertical surface 32a of the frame piece 32 along the irradiation direction of the laser beam is about three times the thickness of the lid plate 31. Thus, even with the lid plate 31 having a reduced thickness in order to achieve a weight reduction thereof, a sufficient laser welding margin with respect to the inner wall surface 5b of the opening 5 can be obtained at the time of the laser welding, thereby allowing for firm laser welding to the case body 4.

Due to the upwardly-formed frame piece 32 according to the second embodiment, the bottom surface of the lid plate 31 is positioned lower in the interior of the opening 5 as compared with the case of the downwardly-formed frame piece 6 according to the first embodiment. Thus, a housing volume that can be used for housing the power generation elements is reduced in the same case body 4. However, in the second embodiment, since the explosion-proof valve 3, the positioning depressed parts 7, the electrode insertion parts 8, and the like formed on the plane surface of the lid plate 31 can be positioned in the interior of the opening 5 of the case body 4 (below the opening edge 5a), those parts can be prevented from being carelessly brought into contact with a finger or an extraneous material.

Although each of the outer shapes of the lid plates 2 and 31 and the opening 5 has an elongated rectangular shape in the above-described embodiments, they are not particularly limited to these shapes.

Moreover, an aluminum alloy plate or a stainless steel plate has been described as an exemplary material for the case body 4 and the lid plates 2 and 31 in view of the processing easiness and weight thereof. However, the case body 4 and the lid plates 2 and 31 may employ plates made of other materials.

Moreover, although the plurality of ribs 9 and the explosion-proof valve 3 are formed in the lid plates 2 and 31, the present invention can be applied also to a lid plate not necessarily provided with the ribs 9 and the explosion-proof valve 3.

### INDUSTRIAL APPLICABILITY

The present invention is suitable for a hermetically-sealed battery in which peripheries of a case body and a lid plate are laser-welded together and an opening of the case body is thereby hermetically sealed with the lid plate.

### REFERENCE SIGNS LIST

1, 30 hermetically-sealed battery
2 lid plate
3 explosion-proof valve
3a thin-walled portion
4 case body
5 opening
5b inner wall surface
6 frame piece
6b inclined surface
9 rib
32b curved surface (inclined surface)

1. A hermetically-sealed battery comprising:
a case body made of a metal and having an opening;
power generation elements housed in the case body; and
a lid plate made of a metal, the lid plate being fitted into the opening of the case body, the lid plate having a periphery laser-welded together with the case body so as to hermetically seal the opening of the case body with the lid plate, wherein
the lid plate includes a frame piece integrally provided along the periphery of the lid plate so as to be perpendicular to a plane surface of the lid plate,
the frame piece is pressed into the opening along an inner wall surface thereof, and
laser welding is performed along a boundary between the frame piece and the inner wall surface that are in pressure contact with each other.

2. The hermetically-sealed battery according to claim 1, wherein the frame piece has an outer side surface provided with an inclined surface for guiding the frame piece toward an inner side of the opening while abutting against an opening edge of the opening when the frame piece is pressed into the opening along the inner wall surface thereof.

3. The hermetically-sealed battery according to claim 1, wherein
the periphery of the lid plate has a rectangular shape, and
a plurality of ribs along a longitudinal direction and a short-side direction of the rectangular shape are formed on the plane surface and/or a rear surface of the lid plate.

4. The hermetically-sealed battery according to claim 1, wherein the lid plate includes an explosion-proof valve integrally formed therein, the explosion-proof valve including a thin-walled portion which is broken when an internal pressure in the case body reaches a certain value.

5. The hermetically-sealed battery according to claim 4, wherein the frame piece and the explosion-proof valve are formed in the lid plate by processing a thin metal plate by means of pressing.

6. The hermetically-sealed battery according to claim 2, wherein
the periphery of the lid plate has a rectangular shape, and
a plurality of ribs along a longitudinal direction and a short-side direction of the rectangular shape are formed on the plane surface and/or a rear surface of the lid plate.

7. The hermetically-sealed battery according to claim 2, wherein the lid plate includes an explosion-proof valve integrally formed therein, the explosion-proof valve including a thin-walled portion which is broken when an internal pressure in the case body reaches a certain value.

8. The hermetically-sealed battery according to claim 7, wherein the frame piece and the explosion-proof valve are formed in the lid plate by processing a thin metal plate by means of pressing.
